(19) United States
(12) Patent Application Publication
(10) Pub. No.: US 2003/0146595 A1
(43) Pub. Date: Aug. 7, 2003

(54) Bicycle headset construction

(75) Inventor: Robert Wayne Tison, Fletcher, NC (US)

Correspondence Address: NIXON PEABODY, LLP, 8180 GREENSBORO DRIVE, SUITE 800, MCLEAN, VA, 22102, US

(73) Assignee: Cane Creek Cycling Components, Inc., Fletcher, NC

(21) Appl. No.: 10/061,373

(22) Filed: Feb. 4, 2002

(51) Int. Cl. B62K 19/32

(52) U.S. Cl. 280/279

(57) ABSTRACT

A bicycle headset of the type having upper and lower bearing assemblies for facilitating relative rotation between a steerer tube of a bicycle front fork and a head tube of a bicycle frame, each of the bearing assemblies having a bearing cup with cup-shaped portion for holding an annular rotary bearing unit and an axially extending insertion portion for insertion into the head tube, is improved by a stress-relieving undercut being formed as a transition between the cup-shaped portion and the insertion portion. The undercut can extend around the outer periphery of the insertion portion, the underside of the cup-shaped portion or the junction of the flange and cup-shaped portions.

### BACKGROUND OF THE INVENTION

1. Field of the Invention

The present invention relates to headsets of the type that are used to rotationally mount the steerer tube of a bicycle front wheel fork relative to the head tube of a bicycle frame. In particular, the invention relates to the construction of the bearing cup for the headset bearing assembly and the manner in which it is installed in the head tube of a bicycle.

2. Description of Related Art

Historically, headset bearing cups have been designed with a cylindrical portion that is installed with a slight interference fit into a cylindrical head tube. The bearing cups are installed until they can be inserted no deeper as a result of a general 90° change in the geometry of the cup, such that a surface perpendicular to the axis of the cup makes contact with the top or bottom of a parallel plane on the head tube. At the transition between these two perpendicular surfaces of a headset cup C, there is generally no radius (FIG. 6) or a very small radius (FIGS. 7, 7A). It is essential that there exist a very small or no radius because of the typical geometry at the top and bottom of a head tube. Head tubes are generally cylindrical with generally flat surfaces perpendicular to head tube axis. Most head tubes are manufactured such that no chamfer or radius exists at the transition between the generally cylindrical inner diameter and the flat top and bottom surfaces. Even in situations where a chamfer, round or other broken edge exists at these locations of the head tube, the features are usually removed by a secondary process in which the head tube is finish-machined in preparation for assembly with a head tube. The purpose of this secondary process is to make minor corrections to the inner diameter shape and size, flatness of the top and bottom, and perpendicularity of the top and bottom relative to the inner diameter.

There are problems with the current design and the resultant head tube and headset assembly. These problems are:

1. The need for a very small or non-existent radius at the transition from the inserted portion to the shoulder portion results is a very large stress concentration in this area (area S in FIG. 7A), making the cup weaker than if a larger radius were permissible. This stress concentration is separate from stress due to load applied as a result of any potential interference in this area, being a geometric stress concentration which increases the magnitude of stress in this area even as related to the working stresses in the headset cup, as opposed to only the assembly stress.

2. In the situation where even a small radius exists at the area described above for the cup, there is a problem with assembly because the headset cup shoulder cannot reside flush against the top or bottom of a head tube due to an undesired interference between the transition area of the cup and the inner diameter of the head tube if no chamfer or round exists in the adjacent area of the head tube. Or, if enough force is exerted onto the cup during such installation to cause the cup to seat completely against the top or bottom of the head tube, this results in yielding of the cup and/or head tube and/or an undesirable residual stress in the cup and/or head tube. Furthermore, this required installation force may be so great as to damage other areas of the cup during installation.

### SUMMARY OF THE INVENTION

It is therefore a primary object of the present invention to provide a bicycle headset with a headset bearing cup that has been improved so as to overcome the problems encountered by prior art headsets noted above.

This object and others are achieved in accordance with the present invention by the provision of an undercut feature in the headset bearing cup at the transition area between the portion of the cup that is inserted and resides within the bicycle head tube and the portion of the cup that resides above or below the head tube. This results in the following benefits:

1. Reduces the geometric stress concentration at this area of the headset cup.

2. Ensures intimate contact between the headset cup shoulder and top or bottom of a head tube.

3. Eliminates undesired yielding of the headset cup and/or head tube in the described region.

4. Eases assembly by reducing the maximum force required to fully seat a headset cup.

The provision of an undercut may not always be possible with historic standard sizes of head tubes and forks, due to the lack of space between the steerer and the inner diameter of the head tube. However, it is possible to design the inner diameter of the head tube to provide space to accommodate this feature, particular with the trend toward larger steerer tubes and head tubes with larger inner diameters. Furthermore, alternative embodiments can be used in those cases where only minimal space exists between the steerer and the inner diameter of the head tube.

### BRIEF DESCRIPTION OF THE DRAWINGS

FIG. 1 is a cross-sectional view of the steering assembly of a bicycle;

FIG. 1A is an enlarged view of encircled detail “A” of FIG. 1;

FIG. 2 is a partially broken away side view of the bearing cup of the FIG. 1 embodiment;

FIGS. 3-5 are views similar to that of FIG. 2, but of alternative embodiments;

FIG. 6 is a cross-sectional view showing one form of known bearing cup mounted in a head tube;

FIG. 7 is a cross-sectional view showing second form of known bearing cup mounted in a head tube;

FIG. 7A is an enlarged view of encircled detail “A” of FIG. 7;

FIGS. 8 and 8A are views similar to those of FIGS. 1 and 1A, but showing application of the invention to another type of headset; and

FIGS. 9-11 show application of the alternative embodiments of FIGS. 3-5, respectively to bearing cup of the FIG. 8 type headset.

### DETAILED DESCRIPTION OF THE INVENTION

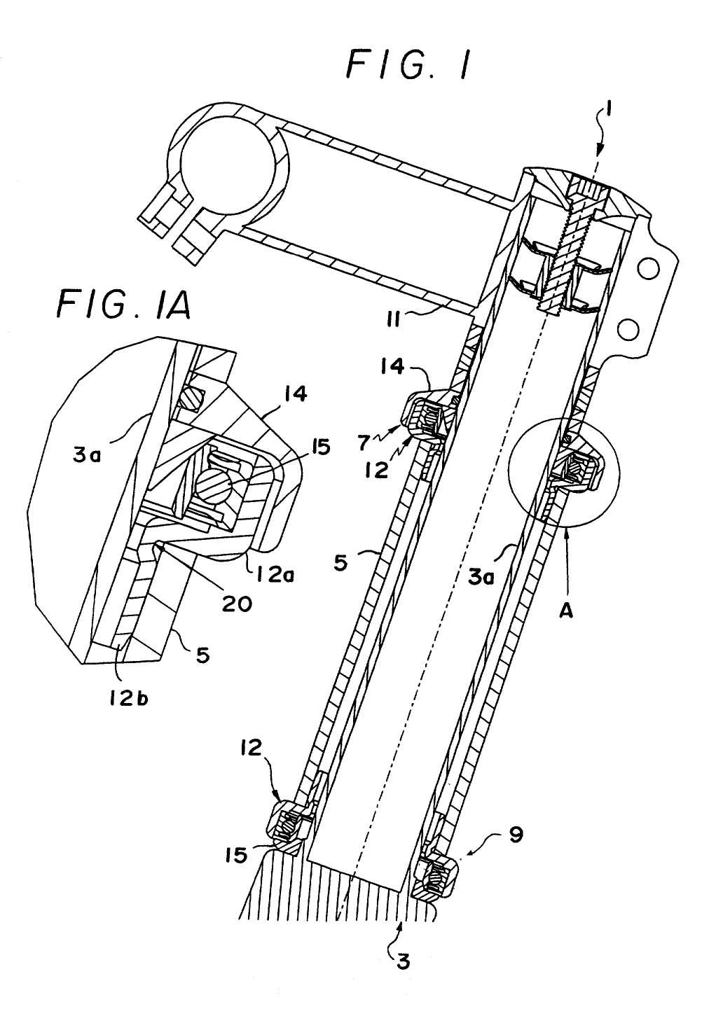

FIG. 1 shows the steering assembly 1 of a bicycle which comprises a front wheel fork 3 with a steerer tube 3a that is supported in the head tube 5 of a bicycle frame by upper and lower bearing assemblies 7, 9 of a headset so as to be able to rotate relative to the head tube 5. Mounted on the steerer tube above the upper headset bearing assembly 7 is a handlebar stem 11.

Each of the headset bearing assemblies has a bearing cup 12 that holds an annular rotary bearing unit 15. Bearing cup 12 has a radially extending portion 12a (which is cup-shaped in this embodiment) that is in intimate contact with a respective end of the head tube 5, and an axially extending insertion portion 12b that is in force fit engagement within the respective end of the head tube 5. Each of the headset bearing assemblies also has a cover 14, which holds the bearing unit 15 in the bearing cup 12 and effects a connection between the headset and the steerer tube 3a which may be a threaded or threadless connection depending on the type of headset. In this regard, it is noted that the present invention is applicable to both threaded and threadless type headsets, and none of the constructional features of a headset or its manner of being assembled and pre-loaded is affected by the present invention in a way that would preclude it from being applicable to virtually any bicycle headset simply by adopting of a bearing cup 12 in accordance with the present invention as will now be described in detail below.

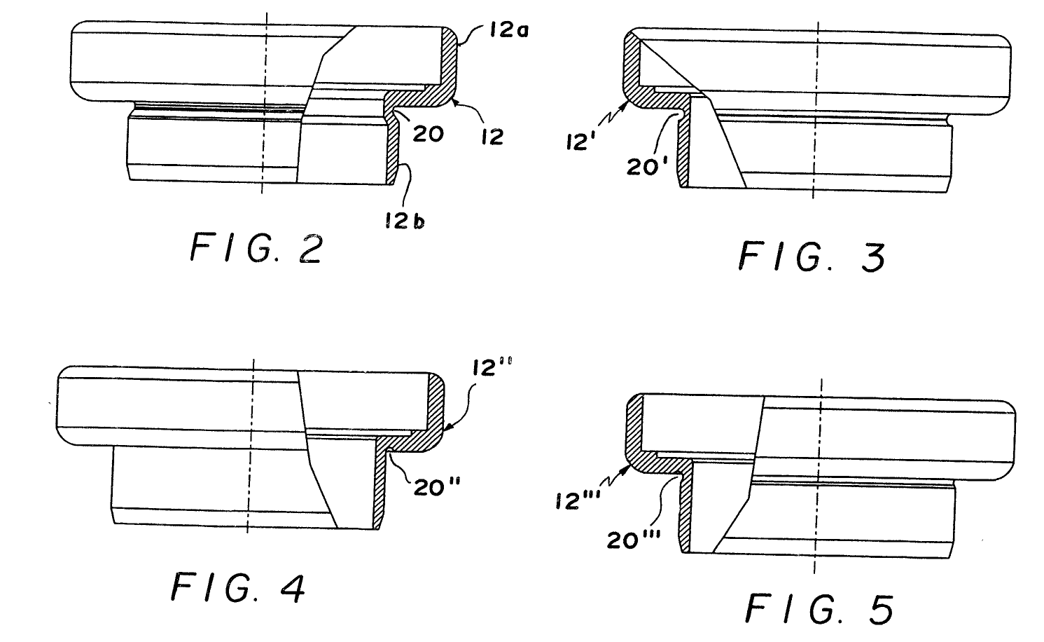

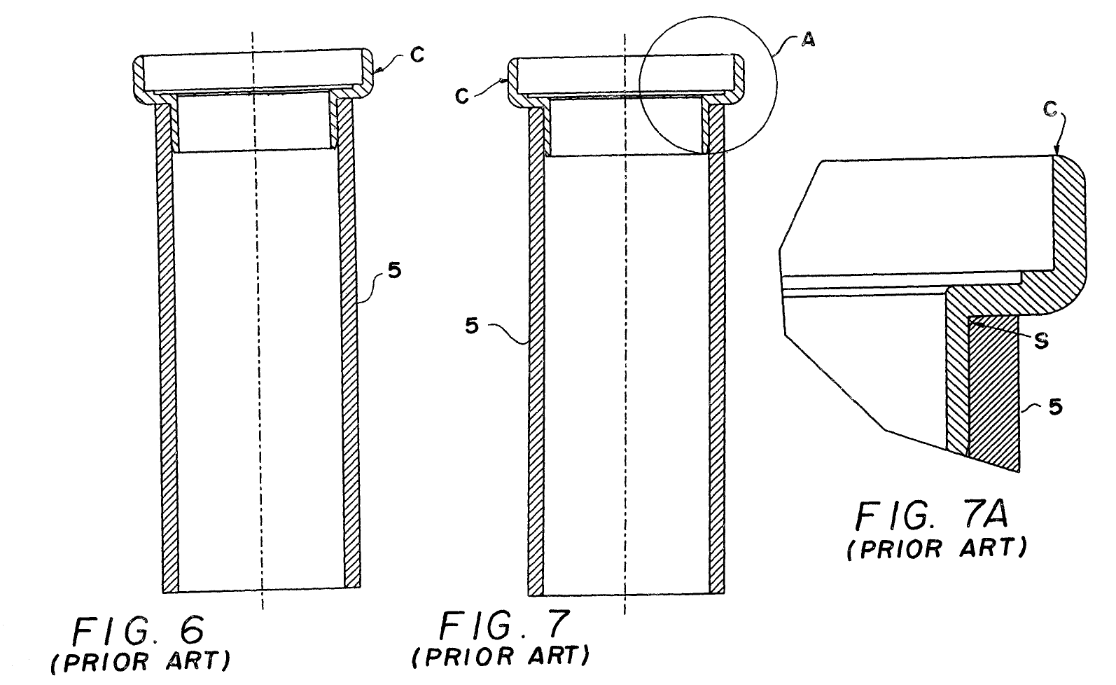

To reduce geometric stress concentrations at the area of the bearing cup 12 where the radially extending portion 12a meets the insertion portion 12b, ensure intimate contact between the underside of the radially extending portion 12a of the bearing cup 12 and the top or bottom of the head tube 5, and eliminate undesired yielding of the headset bearing cup 12 and/or head tube 5 in the region where they meet, an undercut 20 in the form of an annular recess is provided as a transition between the radially extending portion 12a and the insertion portion 12b. The undercut can be provided in the outer periphery of the insertion portion 12b as is the case for the undercuts 20, 20′ shown in the embodiments of FIGS. 2 & 3, or the undercut can be provided in the underside of the radially extending portion 12a as is shown for undercut 20″ in FIG. 4, or the undercut may be provided as for the undercut 20′″ in the outer side of the comer at which the radially extending portion 12a meets the insertion portion 12b (FIG. 5).

The undercut 20, 20′, 20″, 20′″ can be of any shape, but that of FIG. 2 is preferred and begins with a radius or curve at the comer between the radially extending portion 12a and the insertion portion 12b that is as large as possible to negate the stress concentration caused by an abrupt change in geometry. The opposite end of the undercut 20 would also preferably be gradual using either a shallow angle as shown or a large curve. Given typical material thicknesses (about 2 mm), the depth of the undercut will generally be about 1.0 mm. However, in cases where there is sufficient clearance between the inside of the bearing cup and the outer surface of the steerer tube, the wall of the insertion portion 12b can be made thicker with a smaller inner diameter in the region of the undercut to enable the undercut to be made larger.

The length of the undercut in an axial direction, i.e., along the insertion portion 12b is limited only by the need to leave sufficient length for proper fixing of the insertion portion 12b in the head tube 5 by an interference or force fit connection. In the case of the embodiments of FIGS. 4 & 5, the length of the undercut in a radial direction along the underside of the cup portion 12a should be limited to one-half of the thickness of the head tube 5.

With regard to the four embodiments shown in FIGS. 2-5, all are very effective from a standpoint of achieving effective seating of the bearing cup 12 in the head tube 5. However, the embodiment of FIG. 2 is the most effective at reducing stress, followed in order of decreasing effectiveness in reducing stress by the embodiments of FIG. 5, FIG. 3, and then FIG. 4.

The undercut can be produced by machining (e.g., turning) for all embodiments and in the case of the FIG. 4 embodiment, can be produced by forging as well.

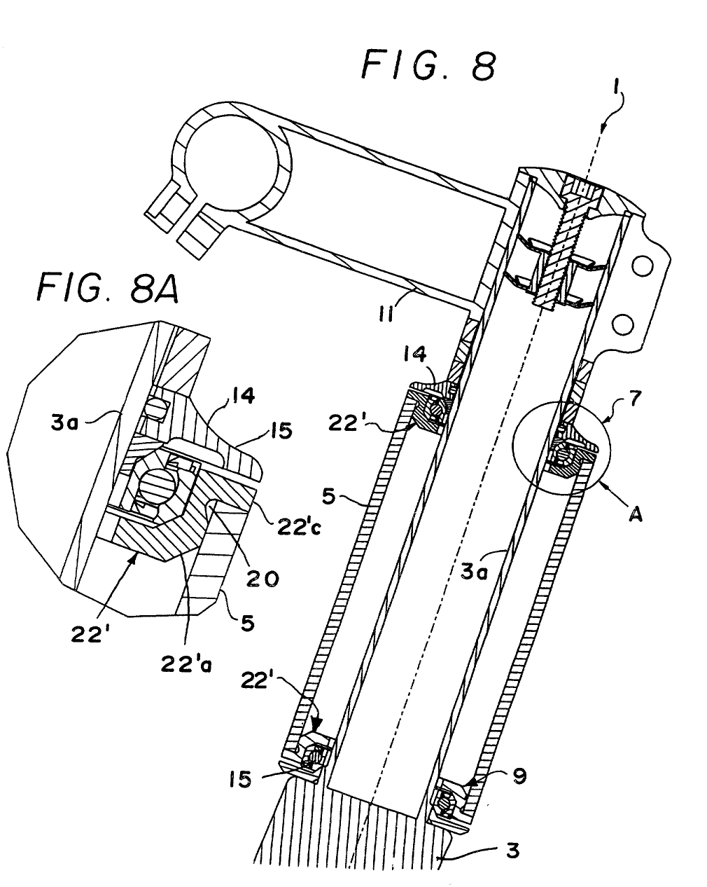

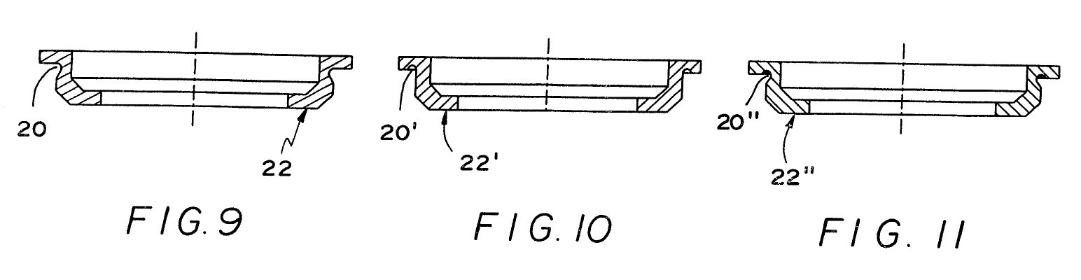

FIGS. 8, 8A, & 9 show application of the invention to a recessed bearing cup type headset. In this case, the bearing cup 22 has a bearing cup portion 22a that is inserted into the head tube 5 and a flange 22c extends radially outward from the open end bearing cup portion 22a for engaging on the end of the head tube 5. In FIGS. 8, 8A, & 9, an undercut 20 of the type shown in FIGS. 1 & 1A is shown applied to the outer surface of the bearing cup portion 22a adjacent to the underside of the radially extending portion 22c. However, the undercut may be shaped and size in any of the manners described above, FIGS. 10 & 11 showing application of the undercuts 20″ and 20′″ (FIGS. 4 & 5) to bearing cups 22′ & 22″.

While various embodiments in accordance with the present invention have been shown and described, it is understood that the present invention is not limited thereto. These embodiments may be changed, modified and further applied by those skilled in the art. For example, while the illustrated embodiments show a cartridge type bearing housed in the bearing cup, the invention is applicable to headsets in which the bearing cup serves as the outer race for the bearing elements. Therefore, this invention is not limited to the details shown and described above and also includes all such changes and modifications which are encompassed by the appended claims.

What is claimed is:

1. In a bicycle headset of the type having upper and lower annular rotary bearing assemblies for facilitating relative rotation between a steerer tube of a bicycle front fork and a head tube of a bicycle frame, each of the bearing assemblies having a bearing cup in which bearing elements are located, wherein said bearing cup has an axially extending insertion portion for insertion into the head tube and a radially extending portion for engaging on an end of a bicycle head tube in an installed state of the headset, the improvement comprising an undercut forming a transition between said radially extending portion and said insertion portion, said undercut being an annular recess extending around the bearing cup.

2. The bicycle headset according to claim 1, wherein the radially extending portion comprises a cup-shaped portion for holding the annular rotary bearing unit, and wherein said axially extending insertion portion is tubular.

3. The bicycle headset according to claim 2, wherein said undercut is formed by an outward expansion of said insertion portion at a distance from said cup-shaped portion.

4. The bicycle headset according to claim 2, wherein said undercut is formed by a groove in an outer surface of the insertion portion adjacent said cup-shaped portion.

5. The bicycle headset according to claim 2, wherein said undercut is formed by a groove in an underside of said cup-shaped portion adjacent said insertion portion.

6. The bicycle headset according to claim 2, wherein said undercut is formed by a groove formed across a junction of an underside of said cup-shaped portion and an outer surface of the insertion portion.

7. The bicycle headset according to claim 1, wherein the insertion portion comprises a cup-shaped portion for holding the annular rotary bearing unit and wherein said radially extending portion extends radially outward from an open end of the bearing cup portion.

8. The bicycle headset according to claim 7, wherein said undercut is formed by a groove in an outer surface of the cup-shaped portion adjacent an underside of said radially extending portion.

9. The bicycle headset according to claim 2, wherein said undercut is formed by a groove in an underside of said radially extending portion adjacent said insertion portion.

10. The bicycle headset according to claim 2, wherein said undercut is formed by a groove formed across a junction of an underside of said radially extending portion and an outer surface of the insertion portion.

11. In a bicycle of the type having a front wheel fork with a steerer tube, a frame with a head tube, and upper and lower annular rotary bearing assemblies for facilitating relative rotation between the steerer tube of the front fork and the head tube of the frame, each of the bearing assemblies having bearing elements and a bearing cup in which the bearing elements are located, wherein said bearing cup has an axially extending insertion portion inserted into the head tube and a radially extending portion engaging on an end of the bicycle head tube, the improvement comprising an undercut forming a transition between said radially extending portion and said insertion portion, said undercut being an annular recess extending around the bearing cup.

12. The bicycle according to claim 11, wherein the radially extending portion comprises a cup-shaped portion holding the annular rotary bearing unit, and wherein said axially extending insertion portion is tubular.

13. The bicycle according to claim 12, wherein said undercut is formed by an outward expansion of said insertion portion at a distance from said cup-shaped portion.

14. The bicycle according to claim 12, wherein said undercut is formed by a groove in an outer surface of the insertion portion adjacent said cup-shaped portion.

15. The bicycle according to claim 12, wherein said undercut is formed by a groove in an underside of said cup-shaped portion adjacent said insertion portion.

16. The bicycle according to claim 12, wherein said undercut is formed by a groove formed across a junction of an underside of said cup-shaped portion and an outer surface of the insertion portion.

17. The bicycle according to claim 11, wherein the insertion portion comprises a cup-shaped portion holding the annular rotary bearing unit and wherein said radially extending portion extends radially outward from an open end of the bearing cup portion.

18. The bicycle headset according to claim 17, wherein said undercut is formed by a groove in an outer surface of the cup-shaped portion adjacent an underside of said radially extending portion.

19. The bicycle according to claim 17, wherein said undercut is formed by a groove in an underside of said radially extending portion adjacent said insertion portion.

20. The bicycle according to claim 17, wherein said undercut is formed by a groove formed across a junction of an underside of said radially extending portion and the insertion portion.
